(19) United States
(12) Patent Application Publication
(10) Pub. No.: US 2016/0046093 A1
(43) Pub. Date: Feb. 18, 2016

(54) METHOD FOR MANUFACTURING PNEUMATIC TIRE

(71) Applicant: SUMITOMO RUBBER INDUSTRIES LTD., Kobe-shi (JP)

(72) Inventors: Kei KOHARA, Kobe-shi (JP); Naoki Sugiyama, Kobe-shi (JP)

(73) Assignee: SUMITOMO RUBBER INDUSTRIES LTD., Kobe-shi (JP)

(21) Appl. No.: 14/823,018

(22) Filed: Aug. 11, 2015

(30) Foreign Application Priority Data
Aug. 12, 2014 (JP) 2014-164542

(51) Int. Cl. B29D 30/16

(52) U.S. Cl. CPC B29D 30/1628

(57) ABSTRACT

A method for manufacturing a pneumatic tire includes helically winding a first rubber strip including first composition on outer side of a rigid core in circumferential direction of the core such that a first rubber layer including the first strip is formed to have first overlapped portions overlapping side edges of the first strip in helical pattern, and helically winding a second rubber strip including second composition on external surface of the first layer in the same winding direction as the first strip such that a second rubber layer including the second strip is formed to have second overlapped portions overlapping side edges of the second strip in helical pattern. The core has external surface shaped to form inner cavity of a pneumatic tire, and the winding of the second strip includes winding the second strip such that each second overlapped portion is formed between adjacent first overlapped portions.

### CROSS-REFERENCE TO RELATED APPLICATIONS

The present application is based upon and claims the benefit of priority to Japanese Patent Application No. 2014-164542, filed Aug. 12, 2014, the entire contents of which are incorporated herein by reference.

### BACKGROUND OF THE INVENTION

1. Field of the Invention

The present invention relates to a method using a rigid core for manufacturing a pneumatic tire, more specifically, to a method for reducing molding defects.

2. Description of Background Art

JP 2011-31582 A has been proposed as a related technology. However, this technology is not related to a method using a rigid core for manufacturing a pneumatic tire. The entire contents of this publication are incorporated herein by reference.

### SUMMARY OF THE INVENTION

According to one aspect of the present invention, a method for manufacturing a pneumatic tire includes helically winding a first rubber strip including a first composition on an outer side of a rigid core in a circumferential direction of the rigid core such that a first rubber layer including the first rubber strip is formed to have first overlapped portions overlapping side edges of the first rubber strip in a helical pattern, and helically winding a second rubber strip including a second composition on an external surface of the first rubber layer in the same winding direction as the first rubber strip such that a second rubber layer including the second rubber strip is formed to have second overlapped portions overlapping side edges of the second rubber strip in a helical pattern. The rigid core has an external surface shaped to form an inner cavity of a pneumatic tire, and the winding of the second rubber strip includes winding the second rubber strip such that each of the second overlapped portions is formed between adjacent first overlapped portions.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view showing an example of the pneumatic tire produced by a manufacturing method according to an embodiment of the present invention;

FIG. 2 is a perspective view showing an example of the apparatus for manufacturing a pneumatic tire to be used in a manufacturing method according to an embodiment of the present invention;

FIG. 3 is an enlarged cross-sectional view of a rigid core illustrating a process for forming an inner liner;

FIG. 4 is an enlarged cross-sectional view of a rigid core illustrating a process for forming an insulation layer;

FIG. 5 is a partially enlarged view showing the bead-forming surface on the right side of the rigid core shown in FIG. 4; and

FIG. 6 is a partially enlarged view showing the right half of the rigid core to illustrate the inner liner formed by another embodiment of the present invention.

### DETAILED DESCRIPTION OF THE EMBODIMENTS

The embodiments will now be described with reference to the accompanying drawings, wherein like reference numerals designate corresponding or identical elements throughout the various drawings.

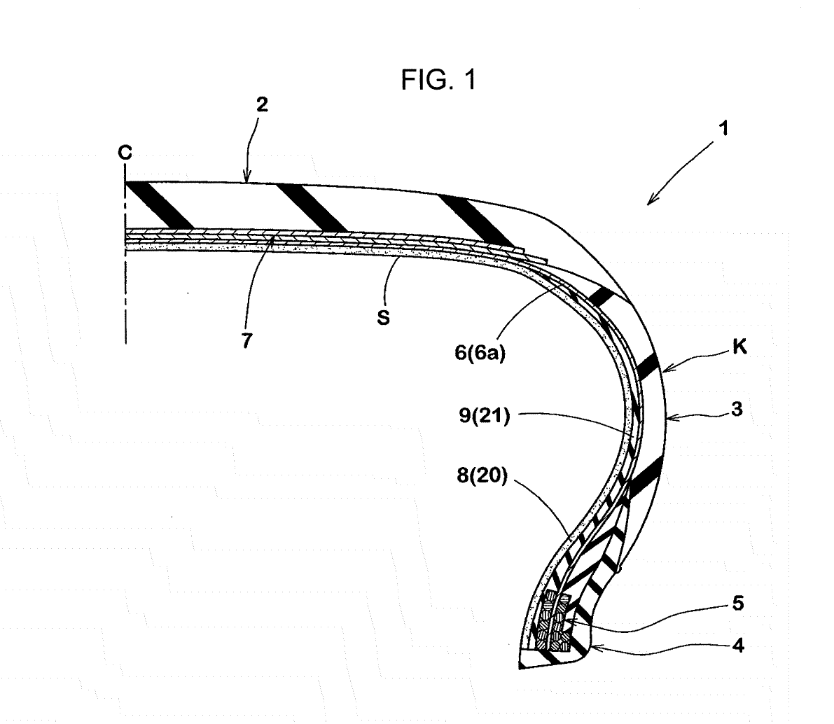

FIG. 1 shows a right-half cross-sectional view taken at the meridian of a pneumatic tire 1 (hereinafter may also be referred to simply as a “tire”) produced by a method for manufacturing a pneumatic tire according to an embodiment of the present invention. Pneumatic tire 1 of the present embodiment is used preferably for a passenger car, for example.

Tire 1 includes carcass 6 having carcass ply (6a) extending from tread 2 through sidewall 3 to reach bead core 5 of bead section 4; belt layer 7 positioned on the tire radially outer side of carcass 6 and on the inner side of tread 2; inner liner 8 provided on the inner side of carcass 6 and forming inner cavity (S) of the tire; and insulation layer 9 positioned between carcass 6 and inner liner 8. Insulation layer 9 of the present embodiment is provided only on side surface (K) positioned on each of both sides of the tire, and is provided in no other section such as tread 2.

Inner liner 8 is made of a rubber composition with excellent air impermeability properties and is capable of suppressing leakage of air in the tire inner cavity.

Insulation layer 9 is made of a rubber composition with excellent adhesiveness properties, and is preferred to contain natural rubber, for example. Insulation layer 9 contributes to improving adhesiveness between carcass 6 and inner liner 8, thereby enhancing durability.

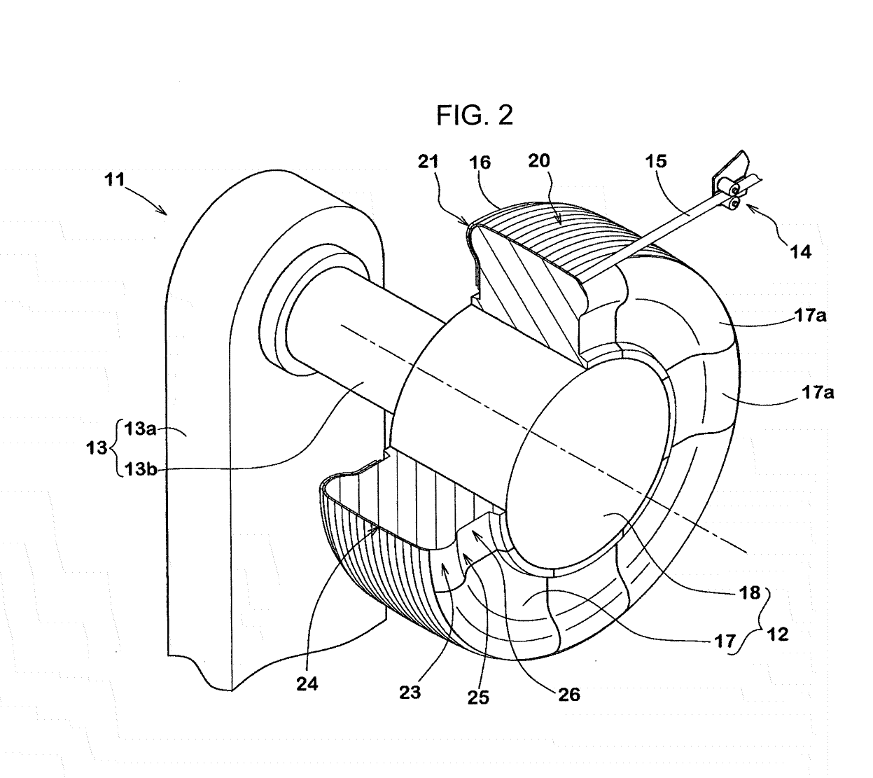

FIG. 2 is a perspective view schematically showing a production apparatus 11 used for manufacturing tire 1 of the present embodiment. As shown in FIG. 2, production apparatus 11 includes the following, for example: rigid core 12 having an external surface to form tire inner cavity (S); support device 13 to support rigid core 12; and applicator 14 to continuously supply narrow ribbon-like rubber strips (15, 16) to rigid core 12. To reduce production time, it is preferred to equip multiple applicators 14 so that one applicator is available for each of rubber strips (15, 16).

Support device 13 is structured to include support frame (13a) and center axis (13b); support frame (13a) is arranged on a floor surface or the like, and one end of center axis (13b) is supported by support frame (13a) to be rotatable. Rigid core 12 is connected to the other end of center axis (13b), which works as a cantilever arm. Accordingly, when center axis (13b) is driven to rotate, rigid core 12 also rotates around the center axis. Center axis (13b) and rigid core 12 are fixed together using removable connector members.

Rigid core 12 includes, for example, an approximately doughnut-shaped core body 17 made up of multiple core segments (17a) arranged in a tire circumferential direction, and inner tube 18 which holds each of core segments (17a) on its peripheral surface.

On the external surface of core body 17, various rubber members are laminated to form a raw tire. When roughly divided, the external surface of core body 17 includes tread-molding surface 24 to form a tread section of tire inner cavity (S), sidewall-molding surface 25 to form a sidewall section of tire inner cavity (S), and bead-molding surface 26 to form a bead section of tire inner cavity (S).

Using the aforementioned production apparatus 11, the manufacturing method of the present embodiment is described below.

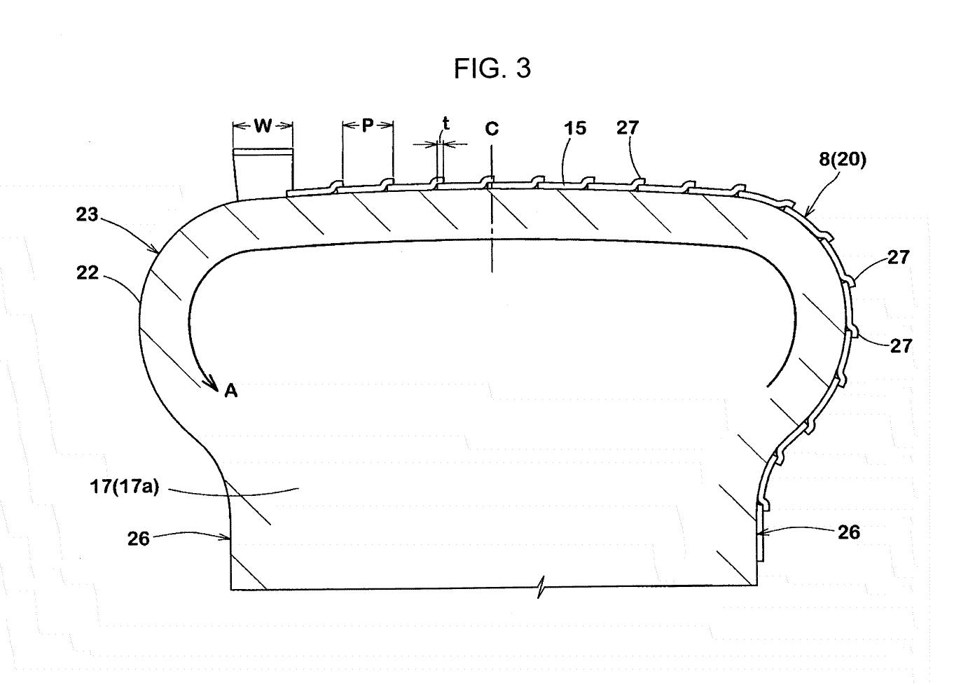

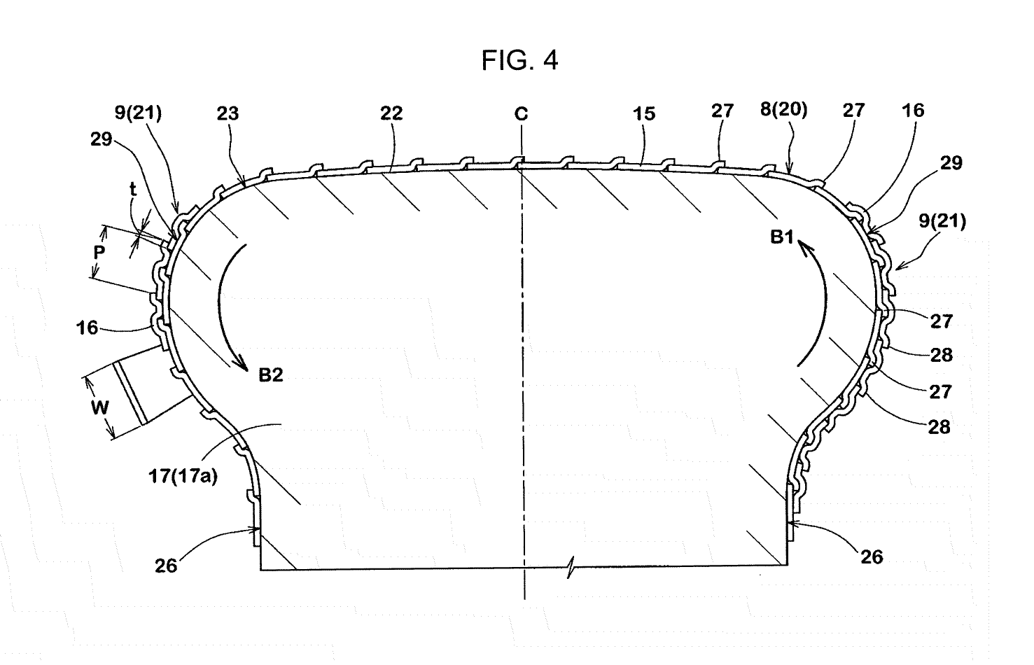

A method for manufacturing a tire 1 according to an embodiment of the present invention includes a process for forming first rubber layer 20 using first rubber strip 15 made of a first composition as shown in FIG. 3; and a process for forming second rubber layer 21 using second rubber strip 16 made of a second composition as shown in FIG. 4. Each of rubber strips (15, 16) is unvulcanized and forms part of a raw tire.

In the description of the present embodiment, first rubber layer 20 corresponds to inner liner 8, and second rubber layer 21 corresponds to insulation layer 9. Therefore, a butyl rubber or butyl-based rubber composition having excellent air impermeability properties is used for first rubber strip 15, while a composition mainly containing natural rubber, for example, having excellent adhesiveness properties is used for second rubber strip 16.

As shown in FIG. 3, inner liner 8 as first rubber layer 20 is formed by winding first rubber strip 15 on external surface 22 of core body 17.

In the present embodiment, first, the starting point to wind first rubber strip 15 is fixed onto bead-molding surface 26 on one side (right side) of core body 17. Unvulcanized first rubber strip 15 is fixed to the starting point by using its own adhesiveness.

Next, rigid core 12 is rotated by support device 13 (see FIG. 2), and applicator 14 is moved along external surface 22 of core body 17 in the direction of arrow (A) at a predetermined speed. Accordingly, first rubber strip 15 is wound on the circumference of the core in the direction of arrow (A) shown in FIG. 3, which is a first helical direction going from one bead-molding surface 26 toward the other bead-molding surface 26 (on the left side).

At that time, by controlling the moving speed of applicator 14, for example, first rubber strip 15 is wound so that a crosswise side edge overlaps another side edge of first rubber strip 15 that has already been wound on core body 17. Accordingly, a first overlapped portion 27 is formed where portions of first rubber strip 15 overlap each other. First overlapped portions 27 are formed continuously in a helical pattern along first rubber strip 15.

In the present embodiment, first rubber strip 15 is wound at a substantially constant pitch (P). Pitch (P) is the length covered by first rubber strip 15 when it moves along external surface 22 of core body 17 in a radial direction while rigid core 12 rotates once. The length corresponds to an approximate distance obtained by subtracting width (t) of a first overlapped portion 27 from width (W) of first rubber strip 15. Width (t) of a first overlapped portion 27 is not limited specifically, but is set, for example, at approximately no greater than 40%, preferably no greater than 30%, of width (W) of first rubber strip 15.

Then, when first rubber strip 15 reaches the other bead-molding surface 26, the rotation of rigid core 12 is halted. In addition, first rubber strip 15 is cut off from the applicator. Accordingly, inner liner 8 is formed on the outer side of core body 17, extending from one bead-molding surface 26 to reach the other bead-molding surface 26. Inner liner 8 of the present embodiment is formed with one continuous first rubber strip 15.

As shown in FIG. 4, a process for forming insulation layer 9 as second rubber layer 21 is conducted by winding second rubber strip 16 on one side (right side) and on the other side (left side) of the external surface of inner liner 8.

First, in a process forming an insulation layer 9 on one side, the starting point to wind second rubber strip 16 is fixed onto inner liner 8, which is near bead-molding surface 26 on one side. At that time, second rubber strip 16 is preferred to be fixed to cover a first overlapped portion 27, for example.

Next, rigid core 12 is rotated by support device 13 (see FIG. 2), while applicator 14 is moved along the external surface of the core body in the direction of arrow (B1). At that time, the rotation direction of rigid core 12 is set so that second rubber strip 16 is wound in the same helical direction as that of first rubber strip 15. Accordingly, second rubber strip 16 is wound on the tire radially outer side, starting from one bead-molding surface 26 in the direction of arrow (B1) shown in FIG. 4, namely, in the same helical direction as that of first rubber strip 15. In the present embodiment, second rubber strip 16 is also wound at substantially constant pitch (P), the same as first rubber strip 15.

In addition, an edge of second strip 16 is placed to overlap another edge of second rubber strip 16 which already has been wound on inner liner 8. Accordingly, a second overlapped portion 28 is formed where portions of second rubber strip 16 overlap each other. Second overlapped portions 28 make a helical pattern on insulation layer 9. Moreover, a second overlapped portion 28 is formed between adjacent first overlapped portions 27 of inner liner 8. In other words, a second overlapped portion 28 is formed not to overlap a first overlapped portion 27.

Next, when second rubber strip 16 reaches the vicinity of buttress 29, which is the tire radially outer region of sidewall-molding surface 25, the rotation of rigid core 12 is halted, and second rubber strip 16 is cut off from the applicator. Accordingly, insulation layer 9 on one side is formed with one continuous second rubber strip 16.

As described above, second rubber strip 16 is wound over first strip 15 to be parallel, or at an angle close to parallel, to first rubber strip 15. Such a setting contributes significantly to preventing first rubber strip 15 and second rubber strip 16 from crossing, thereby forming a flat adhesion interface between the strips. Also, because of such a setting, air is prevented from being trapped between first rubber strip 15 and second rubber strip 16, and molding defects or the like are also prevented during the vulcanization process. In addition, the laminate made up of inner liner 8 and insulation layer 9 is made to have notably small variations in its thickness. As a result, the adhesiveness of the laminate to other tire members is improved and tire productivity is enhanced.

Insulation layer 9 on the other side is formed the same as the insulation layer 9 on one side. Namely, the starting point to wind second rubber strip 16 is fixed onto buttress 29 on the other side of inner liner 8. At that time, second rubber strip 16 is fixed, for example, to cover a first overlapped portion 27, the same as on the one side. Then, rigid core 12 is rotated by support device 13 (see FIG. 2), while applicator 14 is moved in the direction of arrow (B2). Accordingly, second rubber strip 16 is wound from the other buttress 29 toward the other bead-molding surface 26 in the direction of arrow (B2) in FIG. 4, the same helical direction as that of first rubber strip 15. As a result, insulation layer 9 on the other side is formed with one continuous second rubber strip 16.

The thicknesses of first rubber strip 15 and second rubber strip 16 are each preferred to be 0.5 mm or greater, for example, to obtain strength that prevents breaking during winding, and 3.0 mm or less, for example, to obtain a predetermined cross-sectional shape when helically wound. From the same viewpoints, widths (W) of first rubber strip 15 and second rubber strip 16 are each preferred to be set in a range of 5-50 mm, for example.

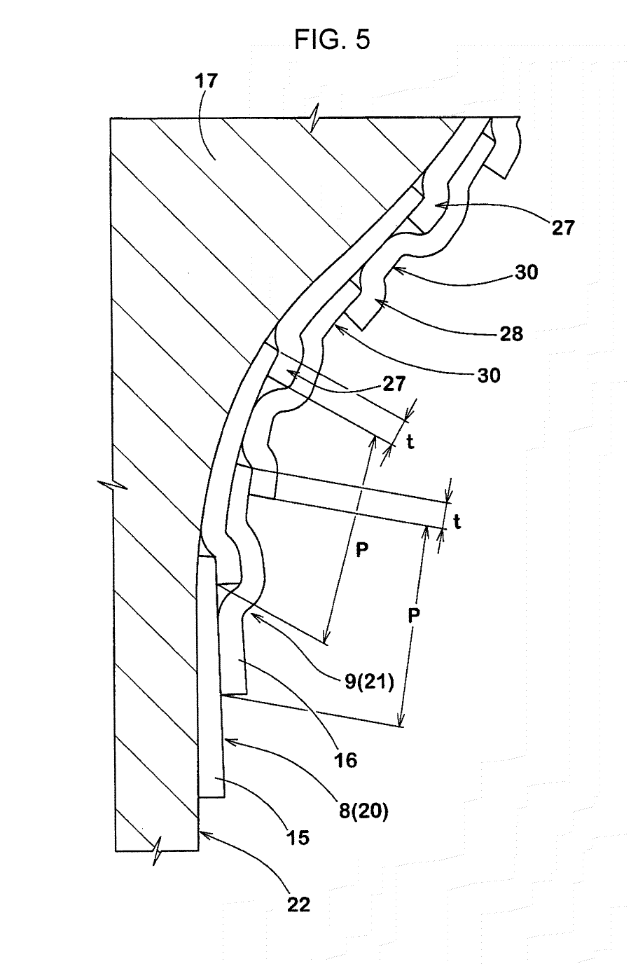

FIG. 5 is an enlarged view showing part of bead-molding surface 26 on one side (right side) of rigid core 12 shown in FIG. 4. As shown in FIG. 5, in a process for forming insulation layer 9, space 30 is preferred to be formed, for example, between a first overlapped portion 27 and a second overlapped portion 28 adjacent to each other. Space 30 is formed by distancing first overlapped portion 27 from second overlapped portion 28. Space 30 is double-layered, formed only with first rubber strip 15 and second rubber strip 16. Spaces 30 are also formed to make a helical pattern in the first helical direction.

When carcass ply (6a) (see FIG. 1) is provided on the outer side of insulation layer 9, spaces 30 make a continuous channel for discharging air between insulation layer 9 and carcass ply (6a). Spaces 30 contribute to further suppressing air from remaining between second rubber strip 16 and carcass ply (6a). Also, since spaces 30 increase the surface area of insulation layer 9, they contribute to further strongly adhering inner liner 8 and carcass ply (6a).

Rigid core 12 is structured to be circular on a side view, and the circumferential distance on its radially outer side is set greater than the circumferential distance on its radially inner side. Accordingly, when first rubber strip 15 and second rubber strip 16 are wound on the side surface of external surface 22 of core body 17 or on the external surface of inner liner 8, the radially outer-side edge is stretched while the radially inner-side edge is compressed. Accordingly, when first rubber strip 15 and second rubber strip 16 are wound, the thickness of the radially outer-side edge tends to be smaller than the thickness of the radially inner-side edge. Thus, a process for decreasing pitch (P) when winding first rubber strip 15 in a helical pattern, for example, is preferred to be included in a process for forming inner liner 8.

For example, on bead-molding surface 26 or sidewall-molding surface 25 where the curvature radius is greater, pitch (P) of first rubber strip 15 is preferred to be gradually made smaller toward the tire radially inner side so as to widen width (t) of a first overlapped portion 27. Such a setting is preferred since the thickness of inner liner 8 is more likely to be uniform and a reduction in strength is prevented even when the thickness of the radially inner-side edge of first rubber strip 15 is reduced. The same setting applies to a process for forming insulation layer 9.

In the manufacturing method of the present embodiment, after insulation layer 9 is formed, carcass ply (6a) (see FIG. 1) is provided on the outer side of inner liner 8 and insulation layer 9. Since the laminate made up of inner liner 8 and insulation layer 9 has a smaller variation in its thickness in the present embodiment, the adhesiveness between the laminate and carcass ply (6a) is improved. In addition, when carcass ply (6a) is laminated, spaces 30 are made flat. Then, other tire rubber members such as belt layer 7 (see FIG. 1) are provided on the outer side of carcass ply (6a), and a raw tire is formed (its entire view is omitted in the drawings). The raw tire is vulcanized with rigid core 12 in a die to obtain pneumatic tire 1.

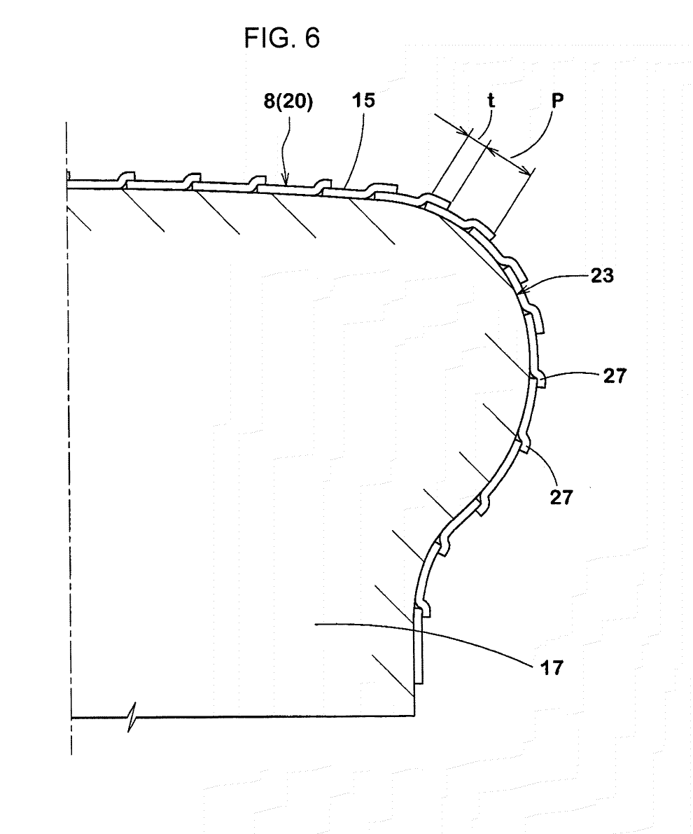

FIG. 6 is a cross-sectional view partially enlarging one side of inner liner 8 formed by another embodiment of the present invention. Generally speaking, in the region of buttress 29 of tire 1, the thickness of rubber members is smaller than that of other sections, thus its strength is relatively low. A process for forming inner liner 8 according to the embodiment shown in FIG. 6 further includes a process for reducing pitch (P) when first rubber strip 15 is wound on buttress region 23 of core body 17. Such a process increases the thickness of inner liner 8 on buttress 29 of tire 1 and enhances the strength in the region. In the embodiment shown in FIG. 6, a process for forming insulation layer 9 is preferred to further include a process for modifying pitch (P) when winding second rubber strip 16 to correspond to pitch (P) when winding first rubber strip 15 (omitted from the drawing).

In the embodiments above, first rubber layer 20 is formed as inner liner 8 and second rubber layer 21 is formed as insulation layer 9. However, the present invention is not limited to such a combination. Needless to say, the present invention can be applied to any combination of two rubber members positioned at least partially adjacent.

So far, preferred embodiments of the present invention have been described. However, the present invention is not limited to those embodiments, and various modifications to the embodiments are possible to carry out the present invention.

### EXAMPLE

A test passenger-car pneumatic tire (size: 215/45R17) having an inner liner and insulation layer was prepared according to a manufacturing method according to an embodiment of the present invention, and the tire performance was tested. Also, as a comparative example, a test passenger-car pneumatic tire was prepared by winding a first rubber strip from one side toward the other side to form the inner liner, and by winding a second rubber strip from the other side toward the one side to form the insulation layer. The test method is shown below.

A hundred tires were produced for each test tire. An inspector visually checked whether there were any molding defects (such as dents) caused by the residual air on the tire inner cavity. As a result, 55 tires of the comparative example were found to have molding defects caused by the residual air. By contrast, only one tire of the example showed molding defects.

A pneumatic tire may be manufactured by a method using a rigid core. A rigid core has an external surface for molding the surface of a tire cavity, for example. On the outer side of a rigid core, tire-forming members such as inner-liner rubber, insulation rubber (indicating rubber to enhance adhesiveness between the inner liner and a carcass ply; the same description being applicable when it appears later) and a carcass ply are laminated in that order to form a raw tire. The raw tire is vulcanized along with the rigid core to mold a pneumatic tire.

In a method using a rigid core to manufacture a pneumatic tire, a narrow unvulcanized ribbon-like rubber strip is used to form inner-liner rubber and insulation rubber. To form an inner liner on the external surface of a rigid core, a first rubber strip is helically wound, for example, from one bead side toward the other bead side. In addition, to form a pair of insulation rubber members respectively on the left- and right-side surfaces of the inner liner, a second rubber strip is helically wound, for example, from the other bead side toward the one bead side. During those winding procedures, the rigid core is rotated in the same direction.

Using the method above, the second rubber strip is wound to cross the first rubber strip since the first rubber strip and the second rubber strip are helically wound in different directions. At portions where the two rubber strips cross, the adhesion interface is roughened, and much air tends to be trapped between the rubber strips. Such trapped air may cause molding defects during the vulcanization process, resulting in an undesirable exterior appearance of a tire.

A manufacturing method according to an embodiment of the present invention is capable of reducing molding defects in the production of a pneumatic tire.

One aspect of the present invention is a method for manufacturing a pneumatic tire using a rigid core having an external surface to form the inner cavity of a tire. The method includes the following processes: by helically winding a first rubber strip made of a first composition on the outer side of a rigid core in a circumferential direction of the core, a process for forming a first rubber layer where first overlapped portions are formed in a helical pattern by overlapping side edges of the first rubber strip; and by helically winding a second rubber strip made of a second composition on the external surface of the first rubber layer in the same direction as that of the first rubber strip, a process for forming a second rubber layer where second overlapped portions are formed in a helical pattern by overlapping side edges of the second rubber strip. In the process for forming a second rubber layer, the second rubber strip is wound so as to form a second overlapped portion between adjacent first overlapped portions.

In a method for manufacturing a pneumatic tire according to an embodiment of the present invention, the first rubber layer corresponds to an inner liner that forms the tire inner cavity, for example, and the second rubber layer corresponds to an insulation layer, for example, provided on the outer side of the inner liner on a side surface of the tire.

In a method for manufacturing a pneumatic tire according to an embodiment of the present invention, it is an option for the process for forming a first rubber layer to include a process for increasing the thickness of the first rubber layer in a buttress region by reducing the pitch when winding the first rubber strip in the buttress region of the rigid core.

In a process for forming a second rubber layer of a method for manufacturing a pneumatic tire according to an embodiment of the present invention, it is an option for the second rubber strip to be wound so as to form a space between first and second overlapped portions adjacent to each other.

A method for manufacturing a pneumatic tire according to an embodiment of the present invention includes the following processes: by helically winding a first rubber strip made of a first composition on the outer side of a rigid core in a circumferential direction of the core, a process for forming a first rubber layer where first overlapped portions are formed in a helical pattern by overlapping side edges of the first rubber strip; and by helically winding a second rubber strip made of a second composition on the external surface of the first rubber layer in the same direction as that of the first rubber strip, a process for forming a second rubber layer where second overlapped portions are formed in a helical pattern by overlapping side edges of the second rubber strip. Moreover, in the process for forming a second rubber layer, the second rubber strip is wound so as to form a second overlapped portion between adjacent first overlapped portions.

According to the aforementioned manufacturing method, the second rubber strip is wound parallel, or at an angle close to parallel, to the first rubber strip. Such a setting contributes significantly to preventing the first rubber strip and the second rubber strip from crossing, and to forming a flat adhesion interface. In addition, since such a setting prevents air from being trapped between the first and second rubber strips, molding defects during the vulcanization process are also prevented. Moreover, the laminate made up of the first and second rubber layers is less likely to show variations in its thickness. Accordingly, the laminate adheres well to other members, thus contributing to enhanced tire productivity.

Obviously, numerous modifications and variations of the present invention are possible in light of the above teachings. It is therefore to be understood that within the scope of the appended claims, the invention may be practiced otherwise than as specifically described herein.

What is claimed is:

1. A method for manufacturing a pneumatic tire, comprising:
helically winding a first rubber strip comprising a first composition on an outer side of a rigid core in a circumferential direction of the rigid core such that a first rubber layer comprising the first rubber strip is formed to have a plurality of first overlapped portions overlapping side edges of the first rubber strip in a helical pattern; and
helically winding a second rubber strip comprising a second composition on an external surface of the first rubber layer in a same winding direction as the first rubber strip such that a second rubber layer comprising the second rubber strip is formed to have a plurality of second overlapped portions overlapping side edges of the second rubber strip in a helical pattern,
wherein the rigid core has an external surface configured to form an inner cavity of a pneumatic tire, and the winding of the second rubber strip comprises winding the second rubber strip such that each of the second overlapped portions is formed between adjacent first overlapped portions.

2. The method for manufacturing a pneumatic tire according to claim 1, wherein the winding of the first rubber strip comprises winding the first rubber strip such that the first rubber layer forms an inner liner which forms the tire inner cavity, and the winding of the second rubber strip comprises winding the second rubber strip such that the second rubber layer forms an insulation layer on an outer side of the inner liner on a side surface of the pneumatic tire.

3. The method for manufacturing a pneumatic tire according to claim 1, wherein the winding of the first rubber strip comprises reducing a winding pitch of the first rubber strip in a buttress region of the rigid core such that a thickness of the first rubber layer is reduced in a buttress region.

4. The method for manufacturing a pneumatic tire according to claim 1, wherein the winding of the second rubber strip comprises winding the second rubber strip such that a space is formed between adjacent first and second overlapped portions.

5. The method for manufacturing a pneumatic tire according to claim 2, wherein the winding of the first rubber strip comprises reducing a winding pitch of the first rubber strip in a buttress region of the rigid core such that a thickness of the first rubber layer is reduced in a buttress region.

6. The method for manufacturing a pneumatic tire according to claim 2, wherein the winding of the second rubber strip comprises winding the second rubber strip such that a space is formed between adjacent first and second overlapped portions.

7. The method for manufacturing a pneumatic tire according to claim 3, wherein the winding of the second rubber strip comprises winding the second rubber strip such that a space is formed between adjacent first and second overlapped portions.

8. The method for manufacturing a pneumatic tire according to claim 5, wherein the winding of the second rubber strip comprises winding the second rubber strip such that a space is formed between adjacent first and second overlapped portions.

9. The method for manufacturing a pneumatic tire according to claim 1, wherein the first composition is an air impermeable rubber composition, and the second composition is an adhesive rubber composition.
